(19) United States
(12) Patent Application Publication
(10) Pub. No.: US 2014/0011059 A1
(43) Pub. Date: Jan. 9, 2014

(54) POWER SUPPLY DEVICE AND VEHICLE EQUIPPED THEREWITH

(71) Applicants: Hiroyuki Hashimoto, Hyogo (JP); Masaki Tsuchiya, Hyogo (JP); Yasuhiro Asai, Hyogo (JP); Takashi Seto, Hyogo (JP); Takahide Komoriya, Hyogo (JP)

(72) Inventors: Hiroyuki Hashimoto, Hyogo (JP); Masaki Tsuchiya, Hyogo (JP); Yasuhiro Asai, Hyogo (JP); Takashi Seto, Hyogo (JP); Takahide Komoriya, Hyogo (JP)

(21) Appl. No.: 14/005,977

(22) PCT Filed: Mar. 29, 2012
(86) PCT No.: PCT/JP2012/058481

§ 371 Date: Sep. 18, 2013

(30) Foreign Application Priority Data
Mar. 31, 2011 (JP) 2011-081313

(51) Int. Cl. H01M 10/50

(52) U.S. Cl. CPC H01M 10/5004; H01M 10/5016
USPC 429/72

(57) ABSTRACT

A power supply device includes a battery cell stack (5) constructed of a plurality of stacked, rectangular battery cells, and a cooling pipe (60) disposed in a thermally coupled state over one surface of the battery cell stack (5), the cooling pipe (60) being adapted to perform a heat exchange with the battery cell stack (5) by allowing a refrigerant to flow inside the pipe, wherein a plurality of rows of the cooling pipes (60) are spaced apart from each other over the one surface of the battery cell stack (5), and a resin member is placed between the spaced-apart cooling pipes (60) such that the one surface of the battery cell stack (5) is covered in a sealed state.

### BACKGROUND OF THE INVENTION

1. Field of the Invention

The present invention relates generally to power supply devices of a large current and also relates to vehicles equipped with such power supply device. The power supply devices are used for driving a motor mounted on a vehicle, such as a hybrid car and an electric car, being also used for an electric storage at homes and factories where a large current is used.

2. Description of the Related Art

There has been a need for a power supply device with a higher output, such as a battery pack used for a vehicle. In such power supply device, a multitude of battery cells are interconnected in series to increase output voltage and output power. When electrically charged and discharged at a large current, the battery cells heat up. In particular, as the number of battery cells used increase, an amount of heat generation also increases. As such, a heat radiation mechanism is needed for efficiently conducting the heat released from the battery cells. Such heat radiation mechanism has so far been proposed like in an air cooling system in which cooled air is blown against the battery cells, and also in a direct cooling system by means of a heat exchange in which a refrigerant is supplied and circulated within a cooling pipe and the cooling pipe is kept in contact with the battery cells (see JP-A-2009-134,901; JP-A-2009-134,936; and JP-A-2010-015,788, for example). In such battery system, as shown in FIG. 15 and FIG. 16 for example, a refrigerant-circulated cooling pipe 260 is placed at the bottom surface of a battery cell stack 205 where battery cells 201 are stacked, and the cooling pipe 260 is connected to a cooling mechanism 269, such that, for the cooling purpose, the heat is deprived of the battery cell stack 205 through the cooling pipe 260 or the cooling plate 261. In the example shown in FIG. 15, the cooling pipe 260 is arranged to extend toward the direction of intersecting a stacked orientation where the battery cells 201 are stacked. On the other hand, in the example shown in FIG. 16, the cooling pipe 260 is arranged to extend toward the direction being parallel to the stacked orientation where the battery cells 201 are stacked. Further, in the example shown in FIG. 17, the cooling plate 261 is placed at the bottom surface of the battery cell stack 205, and the cooling pipe 260 is arranged onto the cooling plate 261 such that, for the cooling purpose, the heat is deprived of the battery cell stack 205 through the cooling plate 261.

In these cooling systems, when compared with the air cooling system in which the cooling air is blown into a space between adjacent battery cells, the heat exchange system of using the refrigerant makes it possible to efficiently deprive of the heat from the battery cells. On the other hand, as a result that the cooled portion becomes relatively low in temperature due to a high cooling capability, the temperature will go below a point of dew condensation, and thus a moisture content in the ambient air is cooled down, being likely to form the dew on the surface of the battery cells. When such dew condensation occurs, an unintended electrical conduction may sometimes occur or a corrosion may also occur. Particularly, in these cooling systems, since the cooling pipe meanders at the bottom surface of the electrical block, a space is defined between the cooling pipes, and thus the moisture content existing here in the ambient air is formed into the dew. It is also likely that the cooling capability of the cooling pipe is lowered by the existing air.

Refer to JP-U-B-34-016929 (1959).

The present invention has been made with a view to solving the conventional problems as described above. One of the major objects of the present invention is to provide a power supply device and a vehicle equipped with such power supply device, in which while a pipe arrangement is simplified in implementing a cooling system using a cooling pipe, a sufficient cooling capability can be exerted by the battery cells.

### SUMMARY OF THE INVENTION

In order to achieve the above-mentioned object, the power supply device according to a first aspect of the present invention is a power supply device including a battery cell stack constructed of a plurality of stacked battery cells, and a cooling pipe disposed in a thermally coupled state over one surface of the battery cell stack, the cooling pipe being adapted to perform a heat exchange with the battery cell stack by allowing a refrigerant to flow inside the pipe, wherein a plurality of rows of the cooling pipes are spaced apart from each other over the one surface of the battery cell stack, and a resin member is placed between the spaced-apart cooling pipes such that the one surface of the battery cell stack can be covered in a sealed state. Thus, a dew condensation resulting from a temperature difference can be avoided when the cooling pipe is covered with the resin member and the battery cell stack is structured in a tightly sealed state, thus enabling an unintended electrical conduction or corrosion to be avoided for a higher reliability.

Further, the power supply device according to a second aspect is provided with a cover casing for surrounding surfaces other than the one surface of the battery cell stack, thus enabling the battery cell stack to be tightly sealed around with the cover casing and the resin member. This enables the battery cell stack to be air-tightly sealed without being exposed to the outside, and a space can be eliminated between the cover casing and the battery cell stack to prevent a dew condensation for avoiding an occurrence of electrical conduction and corrosion.

Further, in the power supply device according to a third aspect, the resin member may be a heat insulating member provided with a heat insulating property. Thus, the battery cell stack can be efficiently cooled down from the one surface through an increased heat insulating property, with the cooling pipe being covered with the resin member.

Further, in the power supply device according to a fourth aspect, the cooling pipe can be covered around by potting the resin member. Thus, as the cooling pipe and the one surface of the battery cell stack can be securely covered by potting to prevent the occurrence of a dew condensation for an increased safety.

Furthermore, in the power supply device according to a fifth aspect, the cover casing can be provided with a surface covering portion between the spaced-apart cooling pipes, the surface covering portion covering the one surface of the battery cell stack. Thus, the amount of the resin member can be reduced for potting between the cooling pipes. An area of a heat conductive sheet can also be reduced, and also the cooling pipe can be positioned in place on the surface covering portion.

Furthermore, in the power supply device according to a sixth aspect, the cover casing covers side surfaces and a top surface of the battery cell stack, and the resin member can cover the one surface of the battery cell stack and also can cover an end surface of the cover casing covering the side surfaces of the battery cell stack, in extension from the one surface. Thus, in addition to a simplified work of storing the battery cell stack in the cover casing, the entire bottom surface can be covered by potting, etc. after storage, which permits enjoying an advantage of readily carrying out the production work.

Furthermore, in the power supply device according to a seventh aspect, the cooling pipe can be arranged such that a plurality of rows of cooling pipe are spaced apart from each other in a substantially parallel form over the one surface of the battery cell stack.

Furthermore, in the power supply device according to an eighth aspect, the plurality of rows of the cooling pipe can be configured by meandering a single piece of the cooling pipe. Thus, the single piece of cooling pipe can efficiently cool down the battery cell stack.

Furthermore, in the power supply device according to a ninth aspect, an insulating, thermally conductive member can further be provided to be interposed between the one surface of the battery cell stack and the cooling pipe. Thus, the thermally coupled state can be improved even better between the battery cell stack and the cooling pipe.

Furthermore, in the power supply device according to a tenth aspect, the resin member may be a urethane-based resin.

Furthermore, in the power supply device according to an eleventh aspect, the cooling pipe may be constructed of an insulating material. Thus, an additional member can be eliminated such as a thermally conductive member, etc. for insulating between the cooling pipe and the battery cell stack.

Furthermore, in the power supply device according to a twelfth aspect, the cooling pipe may be formed into a flat type with its top being flattened. Thus, the thermal coupling can be securely exerted with respect to the battery cell stack on the top surface of the cooling pipe.

Furthermore, in the power supply device according to a thirteenth aspect, the cooling pipe may be made of aluminum. This, since the cooling pipe made of aluminum is relatively soft, a tight contact can be enhanced in the contact with the interface of the battery cell stack, resulting in a higher thermal conductivity.

Furthermore, in a vehicle equipped with a power supply device according to a fourteenth aspect, the above-mentioned power supply device may be employed.

### BRIEF DESCRIPTION OF THE DRAWINGS

FIG. 1 is an exploded perspective view of a power supply device equipped with a power supply device in accordance with a first embodiment of the invention.

FIG. 2 is a perspective view of a battery pack shown in FIG. 1.

FIG. 3 is an exploded perspective view of the battery pack shown in FIG. 2.

FIG. 4 is a schematic plan view of an arrangement of a cooling pipe and showing a cooling mechanism.

FIG. 5 is a schematic sectional view of the battery cell stack shown in FIG. 1.

FIG. 6 is a schematic exploded perspective view showing how the battery cell stack is covered by a cover casing.

FIG. 7 is a schematic exploded perspective view showing how the battery cell stack is covered by a cover casing in accordance with a variation.

FIG. 8a is a schematic sectional view of a battery cell stack in accordance with a second embodiment.

FIG. 8b is a schematic sectional view of a battery cell stack in accordance with a variation.

FIG. 9 is a schematic sectional view of a battery cell stack in accordance with a third embodiment.

FIG. 10 is a schematic sectional view of a battery cell stack in accordance with a fourth embodiment.

FIG. 11 is a schematic sectional view of a battery cell stack in accordance with a fifth embodiment.

FIG. 12 is a block diagram showing an example in which a power supply device is mounted on a hybrid car driven by an engine and a motor.

FIG. 13 is a block diagram showing an example in which a power supply device is mounted on an electric car driven by a motor alone.

FIG. 14 is a block diagram showing an example that the power supply device is used for the purposes of an electric storage.

FIG. 15 is a perspective view of a cooling mechanism for a conventional type of power supply device.

FIG. 16 is a perspective view of a cooling mechanism for another conventional type of power supply device.

FIG. 17 is a perspective view of a cooling mechanism for yet another conventional type of power supply device.

FIG. 18 is a schematic plan view of another type of cooling mechanism.

FIG. 19 is a schematic plan view of even another type of cooling mechanism.

### DESCRIPTION OF THE EMBODIMENT(S)

Various embodiments of the present invention will now be described in conjunction with the accompanying drawings. It should be noted, however, that the embodiments to be described below are merely illustrative of the power supply device and vehicle equipped therewith to embody the spirit of the present invention, and that the scope of the present invention is not limited to the power supply device and vehicle equipped therewith as described below. Also, in the present disclosure, those members described in the appended claims are, in no way, specified to the members described in the embodiments. Particularly, unless otherwise specifically set forth herein, the scope of the present invention is not contemplated to be limiting to but is rather intended to be merely illustrative of the components described in the embodiments, in terms of dimension, material quality, shape, and relative disposition thereof. It should also be noted that the size, locational relationship and the like of the members illustrated in each drawing may be indicated and described in an exaggerated manner for purposes of clarity. Further, in the following description, like names and like numerals designate identical or the same members, a detailed description of which may be suitably omitted. It should also be added that each component constituting the present invention may be either realized in a manner of integrating a plurality of components into the same member to utilize such a member for a plurality of factors, or conversely, may be realized in a manner of sharing a plurality of members to perform a function of one member. Further, some descriptions made in a part of example or embodiment may be applicable to other examples or embodiments.

### Embodiment 1

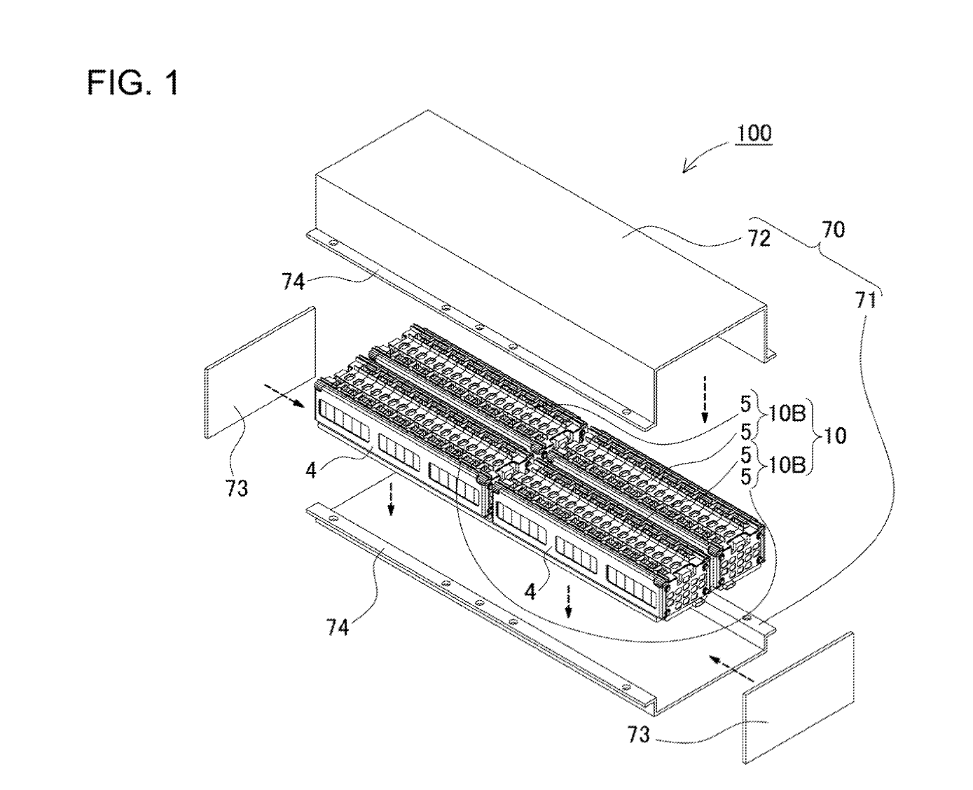

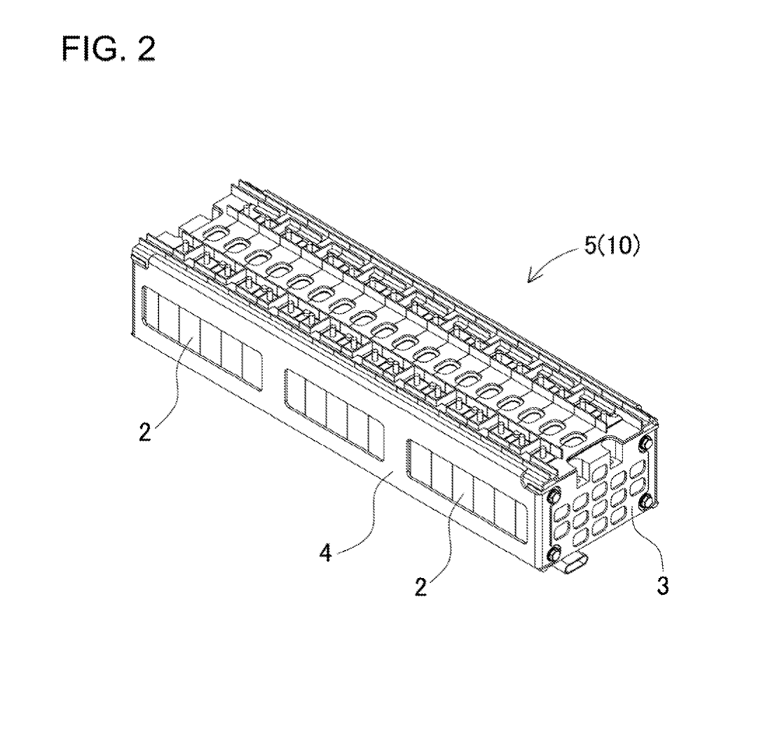

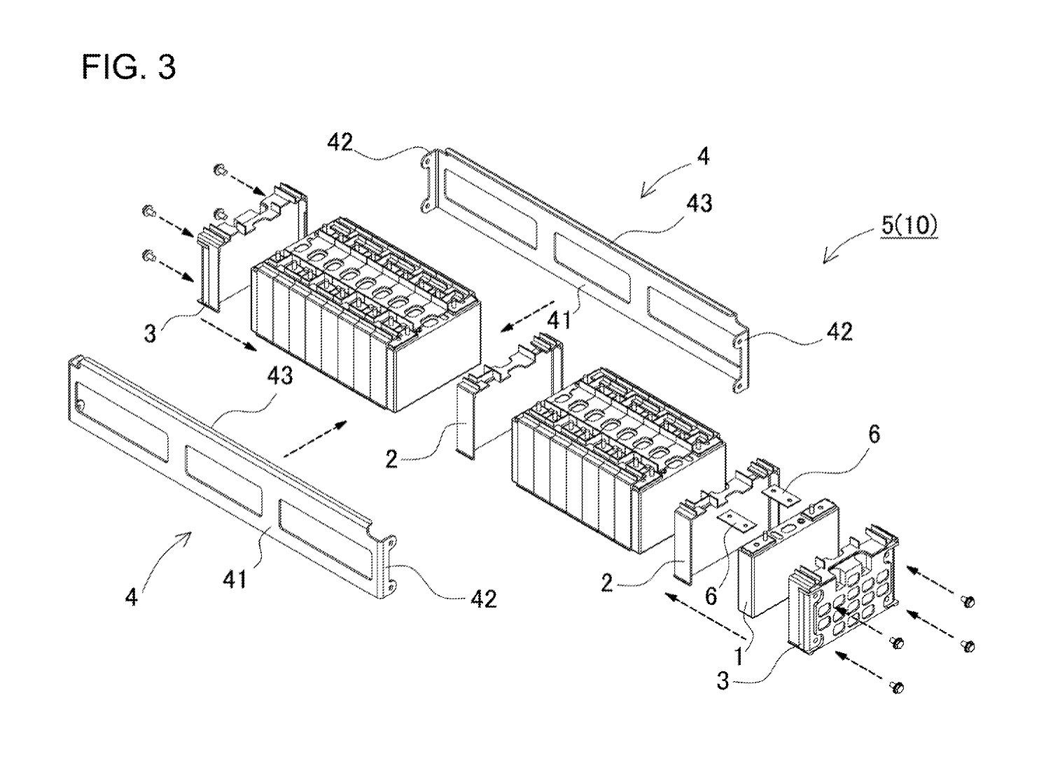

Referring to FIG. 1 through FIG. 3, a description shall now be made on an example in which the power supply device 100 according to Embodiment 1 of the present invention is applied as a power supply device mounted on a vehicle. In these drawings respectively, FIG. 1 is an exploded perspective view of the power supply device 100; FIG. 2 is a perspective view of the battery cell stack 5 as shown in FIG. 1; and FIG. 3 is an exploded perspective view of the battery cell stack 5 as shown in FIG. 2. The power supply device 100 is mainly mounted on an electrically driven vehicle such as a hybrid car and an electric car, and is used as an electric power source for driving a vehicle, by supplying electric power to a driving motor of the vehicle. It should be added that the inventive power supply device can be used for an electrically driven vehicle other than a hybrid car and an electric car, and can also be used for purposes in which a larger output power is required besides the electrically driven vehicle.

### (Power Supply Device 100)

As shown in the exploded perspective view in FIG. 1, the appearance of the power supply device 100 is of a box shape, with its top surface being rectangular. In this power supply device 100, the box-shaped exterior case 70 is separated into two pieces, inside which a plurality of battery packs 10 are stored. The exterior case 70 includes a bottom case 71, a top case 72, and (two pieces of) end plates 73 connected to opposite ends of the bottom case 71 and the top case 72. The top case 72 and the bottom case 71 respectively have a flange 74 extending outwardly, and the flange 74 is fastened by a bolt and a nut. The exterior case 70 has the flange 74 disposed on a side surface of the exterior case 70. Also in the example as shown in FIG. 1, two pieces of battery cell stacks 5 are stored along the length, and two pieces of battery cell stacks are stored along the width, thus making a total of four pieces being stored on the bottom case 71. Each battery cell stack 5 is fixed in place inside the exterior case 70. The end plates 73 are respectively coupled to the opposite ends of the bottom case 71 and the top case 72, sealing up the opposite ends of the exterior case 70.

### (Battery Pack 10)

The battery pack 10, as shown in FIG. 2 and FIG. 3, includes a plurality of rectangular battery cells 1; a separator 2 interposed between the surfaces of the plurality of stacked, rectangular battery cells 1, the separator 2 being stacked for insulating between the rectangular battery cells 1; a pair of end plates 3 placed at opposite end surfaces in the stacked orientation of the battery cell stacks 5, in which the plurality of rectangular battery cells 1 and separators 2 are alternately stacked; and a plurality of metallic binding members 4 for binding together the end plates 3 placed at the opposite end surfaces of the battery cell stacks 5. In addition, the battery cell stack 5 is fixedly placed on a cooling pipe 60 for cooling the battery cell stack 5 (as shall be described in detail below).

### (Battery Cell Stack 5)

The battery pack 10 is so constructed and arranged that a plurality of rectangular battery cells 1, being interposed with an insulating separator 2, are stacked to make up a battery cell stack 5; a pair of end plates 3 are placed at opposite end surfaces of the battery cell stack 5; and the pair of end plates 3 are connected by a binding member 4. In the battery pack 10 illustrated in the above drawings, the separator 2 are interposed between the stacked surfaces of the adjacent rectangular battery cells 1 to insulate the mutually adjacent rectangular battery cells 1, and thus the battery cell stack 5 is made up with the plurality of rectangular cells 1 and separators 2 being alternately stacked.

It should be noted that the battery pack does not necessarily have to have the separator interposed between the rectangular battery cells. For example, a separator is dispensable if the mutually adjacent rectangular battery cells are insulated like in a method of using an insulating material to form an exterior can of the rectangular battery cell, or alternatively in a method of covering around the outer circumference of the exterior can of the rectangular battery cell with a heat shrinkable tube or an insulating sheet or insulating coating materials. A separator does not necessarily have to be interposed between the rectangular battery cells, especially in the configuration that a cooling system is employed for cooling the battery cell stack through a cooling pipe being cooled by a refrigerant, etc., instead of an air cooling system in which a cooling air is forced in between the rectangular battery cells to cool the rectangular battery cells.

### (Rectangular Battery Cell 1)

The rectangular battery cell 1 is square-shaped in which the exterior can constituting the outer shape of the battery cell is thinner in thickness than in width. Positive and negative electrode terminals are provided on a closure plate sealing up the exterior can, and a safety valve is also provided between the electrode terminals. The safety valve is configured to open when an inner pressure in the exterior can is elevated above a predetermined value, enabling the inner gas to be expelled. When the valve opens, an increase in the inner pressure in the exterior can is able to stop. A unit cell constituting the rectangular battery cell 1 is a re-chargeable, secondary battery such as a lithium ion battery, a nickel-hydrogen battery, and a nickel-cadmium battery. In particular, when a lithium ion secondary battery is employed as the rectangular battery cell 1, it is advantageous that a chargeable capacity can be made larger with respect to the volume and mass of the entire battery cell. Further, without limitation to a rectangular battery cell, a battery cell may also be a cylindrical battery cell, a rectangular or otherwise shaped laminated battery cell which is covered with a lamination material around the exterior body.

Each of the rectangular battery cells 1 stacked to constitute the battery cell stack is interconnected in series by using a busbar 6 to couple the adjacent positive and negative electrode terminals. In the battery pack 10 where the adjacent rectangular battery cells 1 are interconnected in series, output voltage can be increased and output power can also be increased. It should be added that in the battery pack the adjacent rectangular battery cells can either be connected in parallel, or in multiple series and in multiple parallel by combining both of series connection and parallel connection. Further, the rectangular battery cell 1 is made of a metallic exterior can. In such rectangular battery cell 1, a separator 2 as an insulating material is interposed in order to avoid a short circuit between the exterior cans of the adjacent rectangular battery cells 1. The exterior can of the rectangular battery cell can also be made of an insulating material such as plastics. In such case, since the rectangular battery cell does not have to be stacked with the exterior can being insulated, the separator may be made of a metal or the separator may be dispensable.

### (Separator 2)

The separator 2 is a spacer for electrically, thermally insulating and layering the adjacent rectangular battery cells 1. The separator 2 is made of an insulating material such as plastics, is placed between the mutually adjacent rectangular battery cells 1, and insulates the adjacent rectangular battery cells 1.

### (End Plate 3)

A pair of end plates 3 are placed at the opposite end surfaces of the battery cell stack 5, in which the rectangular battery cell 1 and the separator 2 are alternately stacked, and the battery cell stack 5 is bound by the pair of end plates 3. The end plate 3 is made of a material with a sufficient strength, for example a metal. The end plate 3 is provided with a binding structure to be bound in joint with the bottom case 71 shown in FIG. 1. Alternatively, the end plate may be made of a resin, or such resin-made end plate may be so structured as to be reinforced with a member made of a metallic material.

### (Binding Member 4)

As shown in FIG. 2 and FIG. 3, the binding members 4 are respectively placed on opposite side surfaces of the battery cell stack 5 in which the end plates 3 are stacked on opposite ends, and the binding members 4 are fixed to the pair of end plates 3 to bind the battery cell stack 5. The binding member 4, as shown in the perspective view in FIG. 3, includes a main portion 41 covering a side surface of the battery cell stack 5, a bending portion 42 bent at opposite ends of the main portion 41 to be fixed to the end plate 3, and a top surface holder portion 43 bent at its upper portion and holding the top surface of the battery cell stack 5. Such binding member 4 is constructed of a material with a sufficient strength, for example, a metallic material. To add, in the example shown in FIG. 1, each of the battery cell stacks is provided with a binding member respectively, and in this case, the binding member binds the opposite end plates located at respective end surface of each battery cell stack. Alternatively, it is also possible to integrally couple the opposite side surfaces by the binding member 4 in a state where two battery cell stacks 5 are placed in the stacked orientation. In such configuration, the binding member 4 is utilized also as a member for coupling the battery cell stacks 5 together. In this instance, the end plates 3 located at opposite surfaces are fixed together by the binding member 4, but the binding member is not fixed to the end plates 3 opposing between the two battery cell stacks 5. Further, it is also possible that the end plates 3 opposing between the two battery cell stacks 5 are commonalized into a single part. It should be noted that the fixture between the end plate and the binding member is not limited to a structure of being fixed by the bolt, etc. described in the embodiment.

### (Cooling Pipe 60)

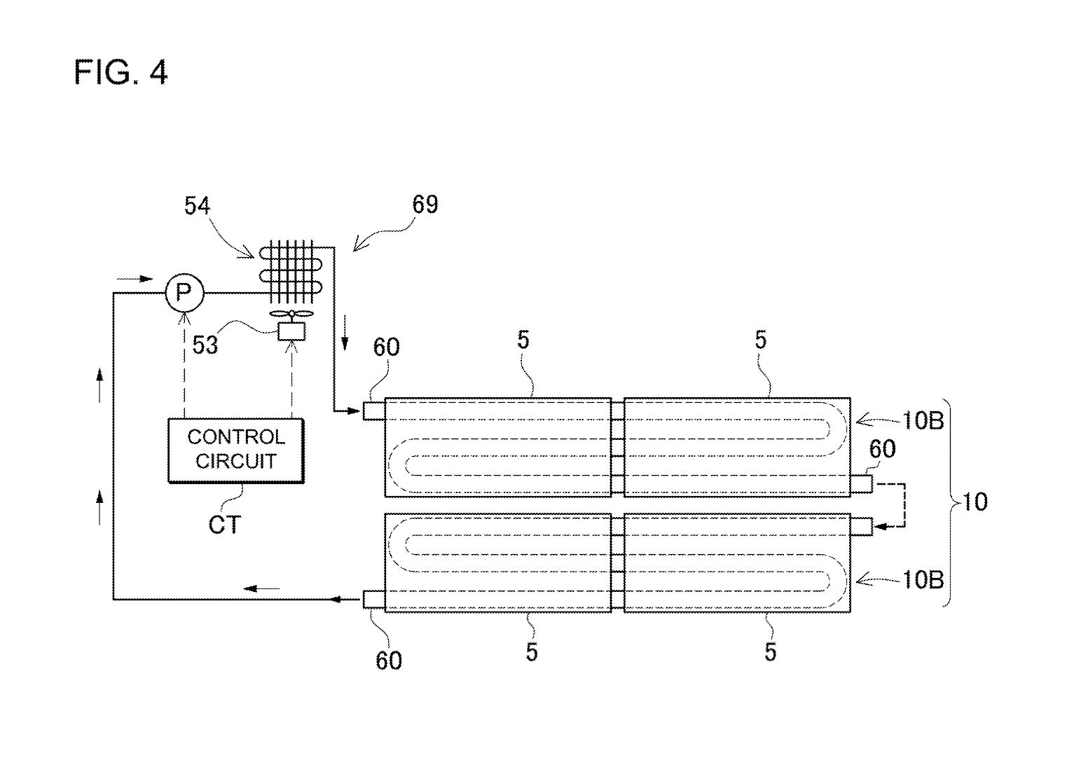

The cooling pipe 60 is a member for thermally conducting and radiating the heat generated from the battery cell stack 5, with a refrigerant being circulated inside the cooling pipe 60. In the example shown in FIG. 4, two battery cell stacks 5 are placed on each cooling pipe 60. As described above, the two battery cell stacks 5 are interconnected in the lengthwise orientation, i.e., in the stacked orientation of the rectangular battery cells 1 to constitute one continuum of stacked batteries 10B. The two battery cell stacks 5 in a state of such interconnection are supported by one piece of cooling pipe 60. And then, as shown in the schematic plan view in FIG. 4, two continuums of these stacked batteries 10B are placed in parallel to constitute the battery pack 10.

In the example shown in FIG. 4, the cooling pipe 60 is extended in the stacked orientation of the rectangular battery cells 1, the cooling pipe 60 is turned back at the edge to meander, and thus three rows of straight cooling pipes 60 are disposed in the stacked orientation of the rectangular battery cells 1 on the bottom surface of the battery cell stack 5. And then, the cooling pipes 60 are interconnected by means of the continuums of the stacked batteries 10B, commonalizing a circulation path of the refrigerant. Alternatively, a plural number of cooling pipes may be placed at the bottom surface of the battery cell stack, and for example, the single piece of meandering cooling pipe shown in FIG. 4 can be divided at the turning point to make up a plural number of cooling pipes. Thus, since the meandering portion can be eliminated, it is possible to save weight. To be noted here is that although each cooling pipe may be connected directly to the cooling mechanism to form separate paths for the refrigerant, the respective cooling pipes may also be interconnected to commonalize the path for the refrigerant. Further, the arrangement of the cooling pipe and its arrangement configuration may be optionally altered, for example, by extending the cooling pipe toward the orientation perpendicular to the stacked orientation of the rectangular battery cell.

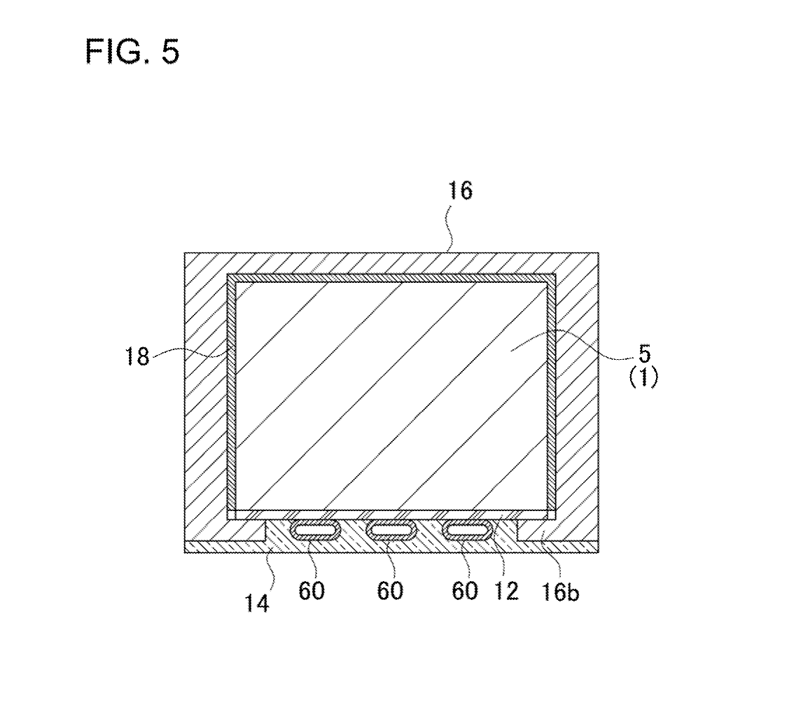

A schematic sectional view of the battery cell stack 5 is shown in FIG. 5. As illustrated, the cooling pipe 60 is formed into a flat shape having a flattened top surface opposite to the battery cell stack. In this design, when compared with a cylindrical cooling pipe, the area in contact with the rectangular battery cell 1 can be increased to securely realize a thermal coupling with the battery cell stack 5. Further, the flat type of cooling pipe can be made lower and thinner in height as compared with a cylindrical cooling pipe with the same area, and so when the height direction of the battery pack is made lower, the battery pack can be made thinner. In addition, the cooling pipe 60 is constructed of a material with an excellent thermal conductivity. Here in this instance, the material is a metal such as aluminum. In particular, since a cooling pipe made of aluminum is relatively soft, it is possible that when the cooling pipe is pressed in contact with the interface of the battery cell stack 5, the surface can be somewhat deformed for an improved tight contact, thus exerting a higher thermal conductivity.

### (Thermally Conductive Sheet 12)

Additionally, interposed between the cooling pipe 60 and the rectangular battery cell 1 is a thermally conductive member such as a thermally conductive sheet 12. The thermally conductive sheet 12 is preferably of an insulating and highly thermally conductive material, and more preferably has a certain extent of resilience. Such material includes a silicone. In this arrangement, an electrical insulation is established between the battery cell stack 5 and the cooling pipe 60. Particularly, when the exterior can of the rectangular battery cell 1 is made of a metal and also when the cooling pipe 60 is made of a metal, an insulation has to be established to avoid a conduction on the bottom surface of the rectangular battery cell 1. As described previously, safety and reliability are enhanced by covering the surface of the exterior can with a heat-shrinkable tube, etc. for insulation, and further by interposing the electrically insulative, thermally conductive sheet 12 for an improved insulating performance. It should be added that when an insulation of the surface of the exterior can is able to be maintained by an insulating material such as a heat-shrinkable tube, etc., the thermally conductive sheet is dispensable. The cooling pipe can also be constructed of an insulating material, and the thermally conductive sheet is dispensable.

On the other hand, when the thermally conductive sheet 23 is provided with a resilience, the surface of the thermally conductive sheet 12 can be elastically deformed to eliminate a space on a contact surface between the battery cell stack 5 and the cooling pipe 60, and thus the thermal coupling state can be better improved. Also instead of the thermally conductive sheet, a thermally conductive paste, etc. can be employed as a thermally conductive member.

### (Heat Insulating Member 14)

Further, in the power supply device shown in FIG. 5, a heat insulating member 14 is disposed as a resin member in the space between the cooling pipes 60. The heat insulating member 14 is a resin having a heat insulating property, and for example a urethane-based resin, etc. can be suitably employed. Here as shown in FIG. 5, the circumference of the cooling pipe 60 is covered by a heat insulating resin in a potting method. In this way, the potting can securely cover the cooling pipe and the bottom surface of the battery cell stack 5 to avoid the occurrence of a dew condensation for an increased safety.

To add description of the example shown in FIG. 5, in a state that the cooling pipe 60 is in abutment with the bottom surface of the battery cell stack 5 through the thermally conductive sheet 12, the space between the cooling pipes 60 as well as the bottom surface of cooling pipe 60 is filled and covered with the heat insulating member 14. It should be noted that the top surface of the cooling pipe 60 can be insulated by filling the heat insulating member 14 on the top surface of the cooling pipe 60 as well, and thus the thermally conductive sheet provided with respect to the rectangular batter cells 1 can also be dispensable.

### (Cover Casing 16)

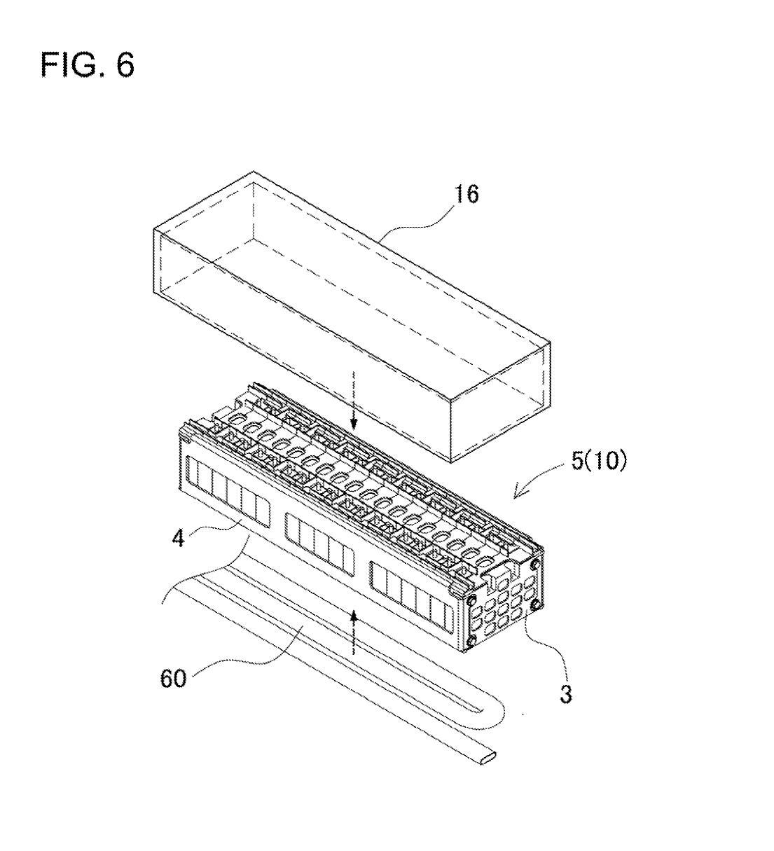

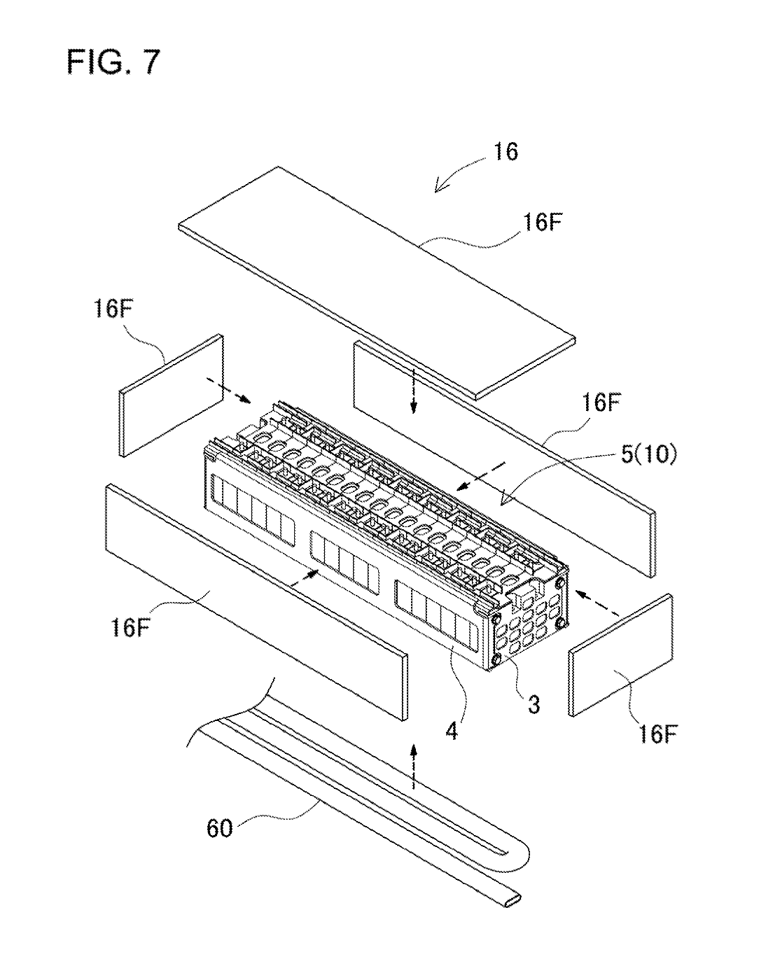

Further, the battery cell stack 5 has its surfaces, except for the bottom surface, covered by a cover casing 16. The cover casing 16 is, for example, box-shaped with the bottom surface being open, and is formed in such size as may store the battery cell stack 5 inside. Such example is shown in the schematic exploded perspective view in FIG. 6. This example, for the purpose of description, shows the cooling pipe 60 disposed on the bottom surface of the battery cell stack 5 in a state of being covered by the heat insulating member 14. In this configuration, the surface of the battery cell stack 5 fixed by the binding member 4 is stored in the cover casing 16 made of a resin, for example.

If the cover casing is made of a metal, and the battery cell stack 5 unbound by a binding member, etc. is press-inserted into the cover casing, the battery cell stack 5 can be maintained in a bound state without using a binding member, thus making the binding member dispensable.

It should be added that the configuration shown in FIG. 6 is merely an example, and another configuration may also be made such that the cover casing 16F is disassembled, and the top surface and side surfaces are covered by separate members. In such instance, another configuration is needed that the battery cell stack 5 is bound further by the binding member 4.

Also, the cover casing 16 thus configured is preferably combined with the heat insulating member 14 to be hermetically structured to seal up the circumference of the battery cell stack 5. In particular, the surfaces other than the bottom surface of the battery cell stack 5 are covered by the cover casing 16, and the bottom surface can be made in a sealed state by the cooling pipe 60 and the heat insulating member 16 filling the space between the cooling pipes 60. In this way, by air-tightly sealing the battery cell stack 5 so as not to be exposed to the outside, the rectangular battery cell 1 is not exposed to the outside. When the battery cell stack 5 is cooled from the bottom surface by the cooling pipe 60, the surface of the rectangular battery cell 1 can be prevented from a dew condensation to avoid an unintended conduction and corrosion, for an increased reliability. That is, by eliminating the air layer around the cooling pipe and by covering the cooling pipe by the heat insulating member, heat insulation is established to realize a highly efficient cooling by the cooling pipe. Also as a result of realizing a highly efficient cooling in this way, multiple rows of cooling pipes do not have to be placed on the bottom surface of the battery cell stack like in a conventional method, whereas a sufficient cooling effect results from even a smaller number of rows such as two rows or three rows, assuring a simplified cooling mechanism and a weight-saved power supply device. Also in this method, since the battery cell stack can be cooled, without an intermediation of a metallic plate such as a cooling plate, in direct contact with the cooling pipe in which the refrigerant flows, a slimming effect, a weight-saving effect and a down-sizing effect can thus be achieved.

Further, the heat insulating member is not limited to filling or potting a resin. Other configuration may be optionally utilized like of laying heat insulating sheets, placing heat insulating cushioning materials, layering plural pieces of heat insulating sheet, and so on. In the present specification, such material is inclusively referred to as a resin member. And as a resin member, a thermally conductive member with a high thermal conductivity may also be utilized instead of the heat insulating member. By utilizing a thermally conductive member, a thermal conduction can be realized not only in an adhesion surface with respect to the cooling pipe but also in a larger area with respect to the battery cell, for an improved release of heat. Also when potting a resin with a high thermal conductivity, the thermally conductive sheet placed between the cooling pipe and the battery cell can be substituted by a potting, and thus the thermally conductive sheet can be made dispensable. Further, the heat insulating member can be used in joint with the thermally conductive member to be placed around the cooling pipe.

### (Cushioning Member 18)

Further as shown in FIG. 5 etc., a waterproof structure of the battery cell stack can also be realized by placing a cushioning member 18 in a space between the battery cell stack 5 and the cover casing 16. In other words, when the cushioning member 18 is filled in the space between the battery cell stack and the cover casing, a situation can be avoided that a dew formed from the moisture content of the air existing in the space affects the battery cell stack adversely. For such cushioning member 18, a filler can be utilized, for example. For such filler, a urethane based resin is suitably utilized. By filling the filler in this way, the space can be eliminated to protect the surface of the battery cell and to avoid a conduction and corrosion which may be caused by a dew condensation.

### (Water-Absorbing Sheet)

Alternatively, a water-absorbing sheet may be utilized as a cushioning member 18. The water-absorbing sheet is a moisture absorbent, water absorbent sheet material composed of a polymeric material, etc. The use of this sheet makes it possible to avoid a dew condensation in a simple configuration and at a lower cost, without experiencing a complicated process like a potting, etc. Further, the cushioning member 18 is not limited to them, but an alternative configuration can be optionally utilized like in a sealing structure using a packing, an O-ring, or a gasket, a sheet-form resilient member and other potting material, or in a configuration of containing the battery cell stack in a waterproof bag, etc.

### Embodiment 2

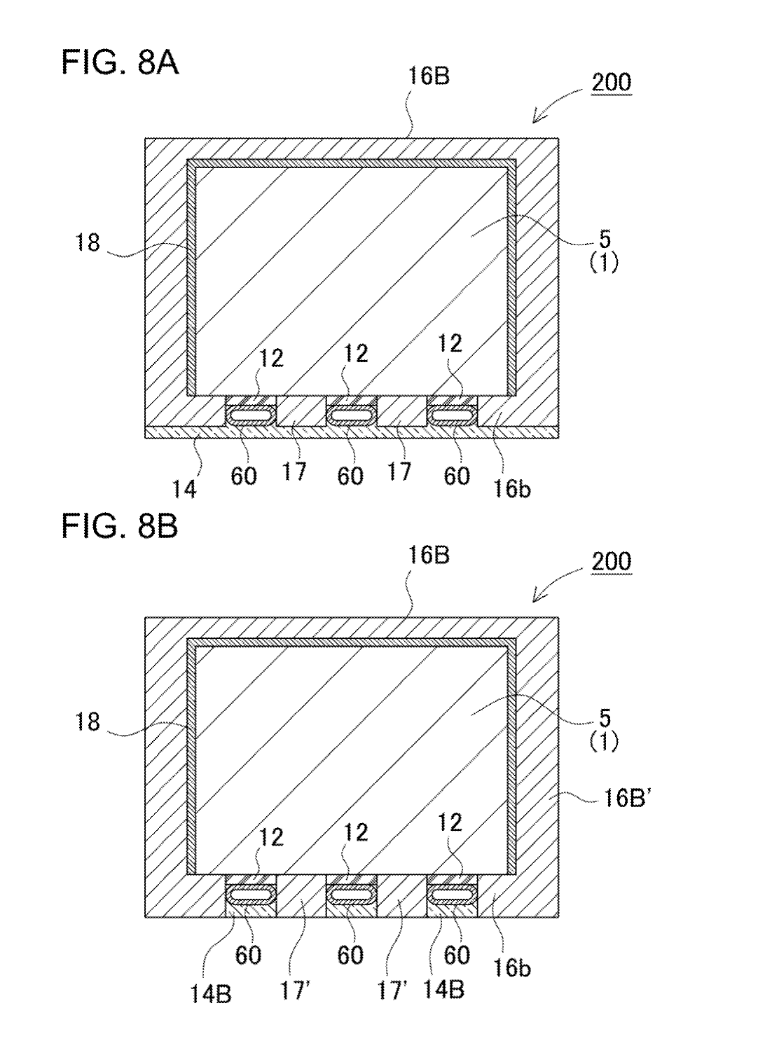

In the above-mentioned example, the heat insulating member 14 is filled between the cooling pipes 60. However, the space between the cooling pipes can also be covered by the cover casing. Such example is shown in FIG. 8a as Embodiment 2. This illustration is a schematic sectional view of the power supply device 200 in accordance with Embodiment 2. The cover casing 16B is provided with a surface covering portion 17 to cover one surface of the battery cell stack 5, being located between the spaced-apart cooling pipes 60 at the bottom surface. The surface covering portion 17 is provided on the bottom surface of the cover casing 16B, the cooling pipe 60 is designed to be disposed in an open portion being slit between the surface covering portions 17, and thus the surface covering portion 17 can be inserted in between the cooling pipes 60. For this purpose, the size of the surface covering portion 17 is so formed as to be insertable into the space between the cooling pipes. Further, like in the case of Embodiment 1, when a resin is filled in the space existing between the surface covering portion 17 and the cooling pipe 60, the space is eliminated to prevent an occurrence of a dew condensation.

In the Embodiment 2, an example has been described that the surface covering portion 17 being a part of the cover casing 16B is utilized as the heat insulating member 14. Without being limited to the cover casing, however, the heat insulating member can also constructed of another member. For example, the heat insulating member may be provided by deforming the bottom surface of the separator interposed between the stacked rectangular battery cells. In this instance as well, the space can be eliminated by filling a resin as another heat insulating member into the space. Alternatively, the surface covering portion may be constructed of a different member to be inserted between the cooling pipes.

In this way, when the space is filled between the cooling pipes, the amount of resin to be potted can be reduced. The thermally conductive sheet can also be reduced in terms of a required area. Further, an accessorial advantage can be attained that a positioning of a cooling pipe can be determined in the surface covering portion.

In the example shown in FIG. 8a, the description has been made on potting a resin on the entire bottom surface of the cover casing 16B. It should, however, be understood that when the heights of the extension 16b and the surface cover casing 17 are elevated in height, the resin can be poured only into the recess where the cooling pipe 60 is disposed. Such variation is shown in FIG. 8b. In this instance, the bottom surface of the cover casing 16B′ is elevated, the surface cover casing 17′ is exposed, and the cooling pipe 60 disposed between the surface cover casings 17′ is covered by the heat insulating member 14B. In this configuration, it is sufficient if only the portion, where the cooling pipe 60 is disposed, is covered by the heat insulating member 14B, and thus the amount of resin to be potted can be reduced.

### Embodiment 3

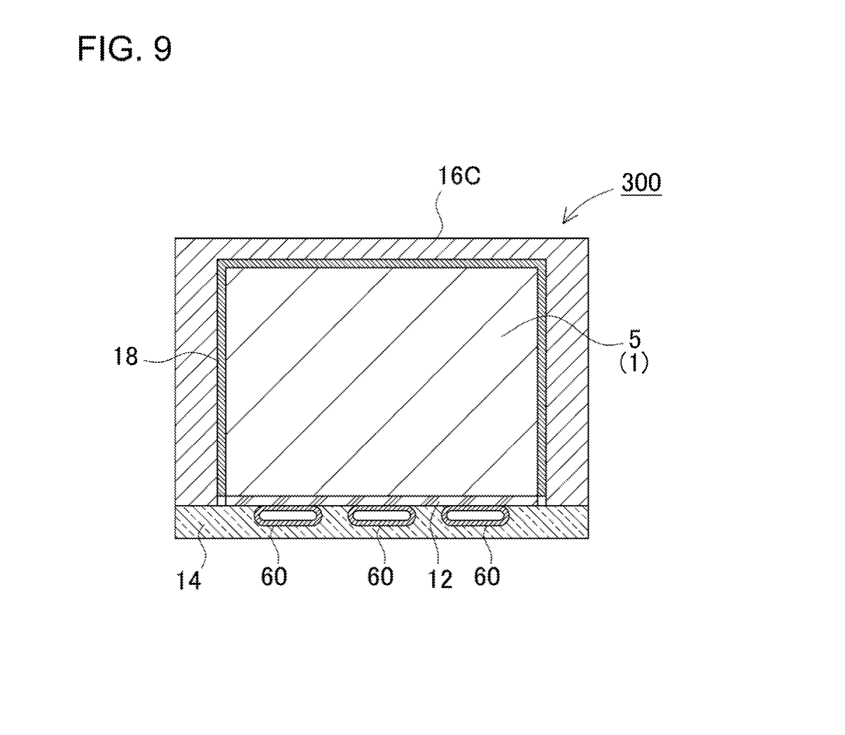

Further, in the above-mentioned example, the cover casing 16B is provided with the extension 16b on the side of the cooling pipe 60 on the bottom surface of the battery cell stack 5, which reduces the amount of used resin. Conversely, such extension is eliminated for a configuration that the entire bottom surface of the battery cell stack is covered by the heat insulating member. Such configuration is shown as Embodiment 3 in FIG. 9. FIG. 9 is a schematic sectional view of the power supply device 300 in accordance with the Embodiment 3. In this configuration, although an amount of used resin increases, the configuration has the advantages in that the bottom surface of the cover casing 16C is fully opened, that a work of storing the battery cell stack 5 in the cover casing 16C can be readily carried out, and that the work involved in a manufacturing process can be simplified.

### Embodiment 4

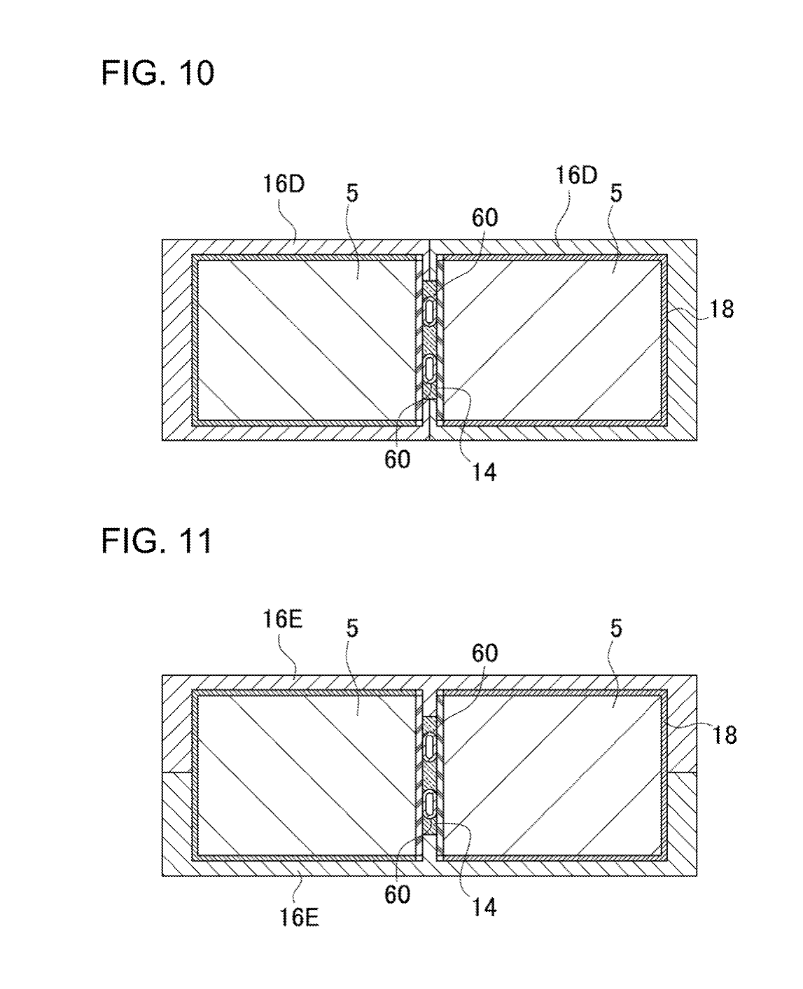

Further, in the above-mentioned example, a description was made about the configuration where the cooling pipe is arranged on the bottom surface of the battery cell stack, but in the present invention, without being limited to this particular arrangement, the battery cell stack can also be cooled by the cooling pipe placed on an alternative surface of the battery cell stack. For example, the cooling pipe may be placed on the side surface of the battery cell stack. In this instance, the bottom surface of the battery cell stack can be covered by the cover casing 16. In this way, when the cooling pipe is placed on the side surface of the battery cell stack, the cooling pipe can also be utilized in common (with other battery cell stack). At this time, the cooling pipe may be placed on the opposite side surfaces of the battery cell stack, and yet the number of the surfaces at which the cooling pipe is placed can be optionally altered. In the Embodiment 4 shown in FIG. 10, the cooling pipe 60 is disposed between the adjacent battery cell stacks 5 placed in parallel with the stacked orientation of the rectangular battery cells 1. In this configuration, it is advantageous that when the battery cell stack 5 is kept in contact on both sides of the upright cooling pipes 60, two of the battery cell stacks 5 or the continuum 10B of the stacked batteries can be cooled by a single piece of cooling pipe 60.

Further, in addition to the configuration that the battery cell stack 5 is individually covered, the cover casing 16D can also cover a plurality of battery cell stacks 5 being put together. For example, in the Embodiment 5 shown in FIG. 11, the cover casing 16E is horizontally divided into two upper and lower pieces, the side-by-side battery cell stacks 5 or the continuum 10B of the stacked batteries are put together and covered up, to thus simplify the covering structure.

### (Cooling Mechanism)

The cooling pipe 60 is connected to the cooling mechanism. The cooling mechanism is provided with a refrigerant circulation mechanism, for example. FIG. 4 shows an example of such refrigerant circulation mechanism. As described above, the cooling pipe 60 is disposed in a state of being thermally coupled to the rectangular battery cell 1 constituting the battery cell stack 5. The cooling pipe 60 is arranged as a refrigerant pipe for allowing the refrigerant to flow inside the pipe, and the cooling pipe 60 is coupled to the cooling mechanism 69. In addition to being able to directly and effectively cool by allowing the battery cell stack 5 to contact the cooling pipe 60, this power supply device also permits cooling other members such as an electronic circuit disposed on the end surface of the battery cell stack.

The cooling pipe 60, serving as a heat exchanger, is arranged as a refrigerant pipe made of copper, aluminum, etc. for circulating the liquefied refrigerant in a state of coolant. The coolant is supplied from the cooling mechanism 69 into the cooling pipe 60 for a cooling purpose. The coolant supplied from the cooling mechanism 69 is made into a refrigerant for cooling by the heat of vaporization evaporated inside the cooling pipe 60, for a more efficient cooling purpose.

Further, the cooling pipe 60 also serves as a heat equalizing means to equalize the temperatures existing in a plurality of rectangular battery cells 1. That is, the difference in temperature among the rectangular battery cells are reduced when the cooling pipe 60 adjusts the heat energy absorbed from the rectangular battery cell 1, to efficiently cool the rectangular battery cell having an elevated temperature, for example the rectangular battery cell in the center portion, and to reduce a cooling effect at an area having a lowered temperature, for example the rectangular battery cells at the opposite ends. In this way, temperature unevenness is reduced among the rectangular battery cells, as a result of which a situation of an excessive electric charge and an excessive electric discharge can be avoided which are caused by a part of rectangular battery cells being deteriorated.

The cooling mechanism 69 shown in FIG. 4 forcibly cools the cooling pipe 60 by means of the heat of vaporization from the refrigerant. This cooling mechanism 69 includes a circulation pump P, a radiator 54, and a control circuit CT for controlling an operation of the circulation pump P and a fan 53 of the radiator 54. The circulation pump P circulates the liquefied refrigerant into the refrigerant path and the radiator 54. The control circuit CT detects a temperature of the battery cell stack 5 by means of a temperature sensor, and drives the circulation pump P when the detected temperature is higher than a predetermined temperature. Further, the control circuit CT detects a temperature of the refrigerant by means of a temperature sensor, and drives the fan 53 of the radiator 54 when the temperature of the refrigerant is higher than a predetermined value. The refrigerant circulated into the refrigerant path by means of the circulation pump P is insulating oil or antifreeze fluid. The insulating oil includes silicone oil, etc. It should be noted that the cooling by the refrigerant includes water cooling in which water or coolant is circulated.

(Cooling Mechanism 69B in Accordance with the Variation)

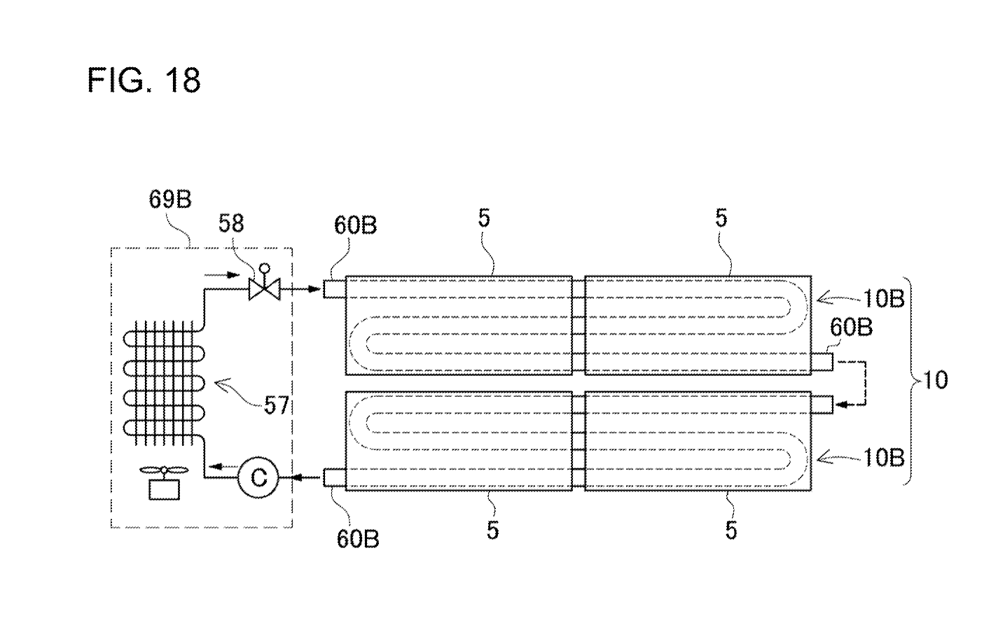

Further, the cooling mechanism can also supply, to the refrigerant path, the refrigerant used to cool by means of the heat of vaporization resulting from vaporizing within the refrigerant path. Shown in FIG. 18 is a cooling mechanism 69B in accordance with such variation. This refrigerant is evaporated inside the refrigerant path to cool the refrigerant path. The cooled refrigerant path cools the battery cell stack 5 from the bottom surface. The cooling mechanism 69B can cool the battery cell stack 5 to a lower temperature. The refrigerant mechanism 69B includes a compressor C for compressing an evaporated refrigerant, a condenser 57 for cooling to liquefy the refrigerant pressurized by the compressor C, and an expander 58 for supplying, to the refrigerant path, the refrigerant liquefied by the condenser 57. The expander 58 is, for example, a capillary tube or an expansion valve. In the capillary tube or expansion valve composed of narrow tubes, a flow rate of the refrigerant is limited to a predetermined range. These expanders 58 are designed to meet with the flow rate of the full vaporization in a state that the refrigerant is expelled from the refrigerant path.

Further, the battery cell 1 can also be cooled by supplying the liquefied refrigerant into the refrigerant path, evaporating such refrigerant inside the refrigerant path, and forcibly cooling by means of the heat of vaporization of the refrigerant. In the cooling mechanism 69B in which the cooling pipe 60B is forcibly cooled by means of the heat of vaporization of the refrigerant, the refrigerant liquefied through the expansion valve 65 is supplied into the cooling pipe 60B, the supplied refrigerant is evaporated inside the cooling pipe 60B, and the cooling pipe 60B is cooled by means of the heat of vaporization. The evaporated refrigerant is pressurized by the compressor C, supplied to the condenser 57, liquefied by the condenser 57, and circulated through the expansion valve 65 into the refrigerant path of the cooling pipe 60B to cool the cooling pipe 60B.

(Cooling Mechanism 69C in Accordance with the Variation)

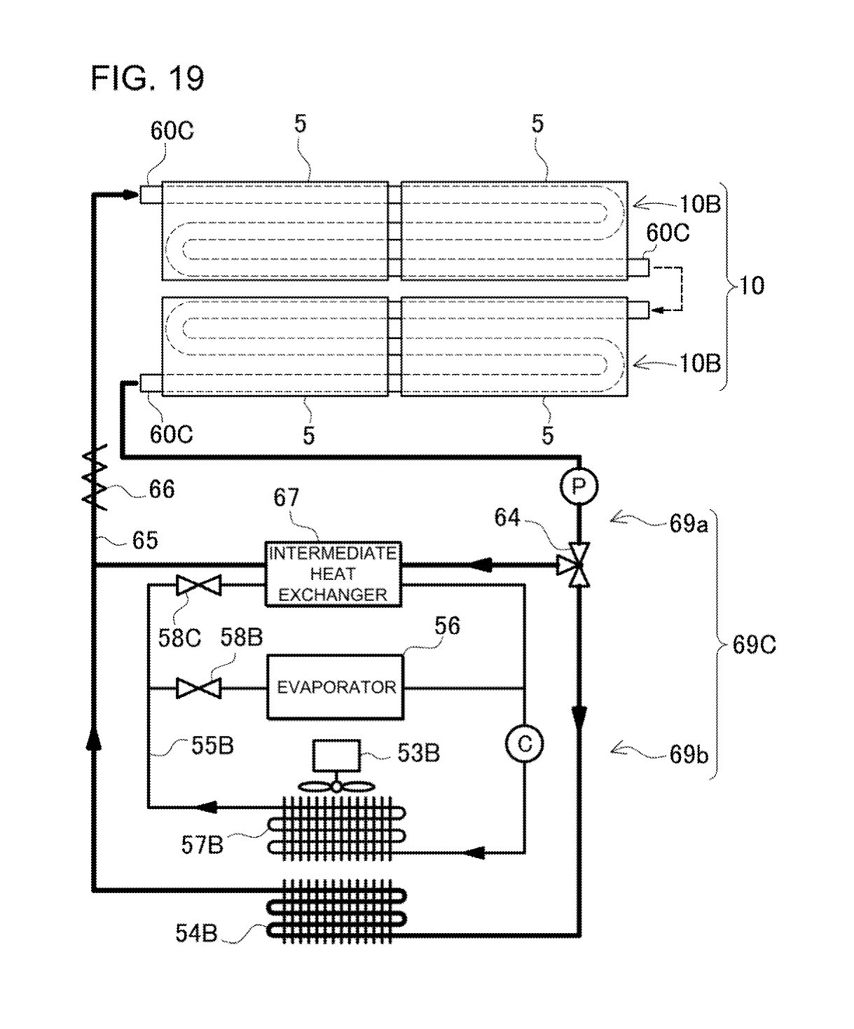

It should be noted that the cooling pipe does not necessarily have to be cooled by means of the heat of vaporization of the refrigerant, but that a water cooling can also be employed in which, for example, cooled liquid is circulated inside the pipe. The cooling pipe can also be cooled by providing a path for a cooling gas inside and forcibly blowing the cooled gas into the path. In addition, when a water cooling method is employed in which water or coolant is circulated, it may be configured that the coolant used for the water cooling is cooled by the refrigerant. Particularly, in the case of a power supply device for a vehicle, the existing cooling mechanism used for an indoor air conditioning purpose, etc. can be utilized for cooling the coolant. FIG. 19 shows a cooling mechanism 69C employing such configuration. In the illustrated cooling mechanism 69C, a first cooling mechanism 69a for cooling the cooling pipe 60C by means of the coolant according to the water cooling method and a second cooling mechanism 69b for cooling inside the vehicle by means of the refrigerant, such as an indoor air conditioner, are connected through an intermediate heat exchanger 67. The first cooling mechanism 69a is so arranged as to include a pump P, a three-way valve 64, an intermediate heat exchanger 67, a heater 66, and a cooling pipe 60C, along a first circulation path 65 as indicated by a thick line. Also connected through the three-way valve 64 is a heat radiator 54B. The heat radiator 54B is air-cooled by the ambient air, and when the ambient air temperature is low, energy consumption involved in cooling, such as power for the compressor C, can be restrained by switching the three-way valve 64 from the intermediate heat exchanger 67 side to the heat radiator 54B side. Further, the heater 66 is a member for controlling a temperature by heating the coolant.

On the other hand, the second cooling mechanism 69b is provided with a compressor C, an intermediate heat exchanger 67, an evaporator 56, and a condenser 57B, along a second circulation path 55B as indicated by a thin line. The intermediate heat exchanger 67 and the evaporator 56 are respectively connected in parallel through the expansion valves 58C, 58B. Further, adjacent to the condenser 57B is a fan 53B. The fan 53B may be used also for heat radiation from the heat radiator 54B. Also in the example shown in FIG. 19, water which contains antifreeze fluid is used as coolant, and HFC (hydrofluorocarbon) is used as a refrigerant.

Thus, with a connection of the first cooling mechanism 69a for the cooling pipe 60C to the second cooling mechanism 69b through the intermediate heat exchanger 67, the coolant can be more efficiently cooled by the existing cooling mechanism, and the cooling of the battery block can be advantageously performed in a steady manner.

As described above, in the power supply device in which a plurality of battery cells 1 are placed with respect to the cooling pipe 60, a temperature fluctuation among the battery cells can be reduced by adjusting a thermal conductance between the battery cell 1 and the cooling pipe 60. Such power supply device can be employed as a power source for a vehicle. Usable as a vehicle being mounted with a power supply device are a hybrid car or a plug-in hybrid car driven by both engine and motor, or an electrically-driven vehicle such as an electric car driven by a motor alone; the power supply device is usable as a power source for these vehicles.

Again, the above-described power supply device is usable as a power source to be mounted on a vehicle. Usable as a vehicle being mounted with a power supply device are a hybrid car or a plug-in hybrid car driven by both engine and motor, or an electrically-driven vehicle such as an electric car driven by a motor alone; the power supply device is usable as an electric source for these vehicles.

### (Power Supply Device for Hybrid Car)

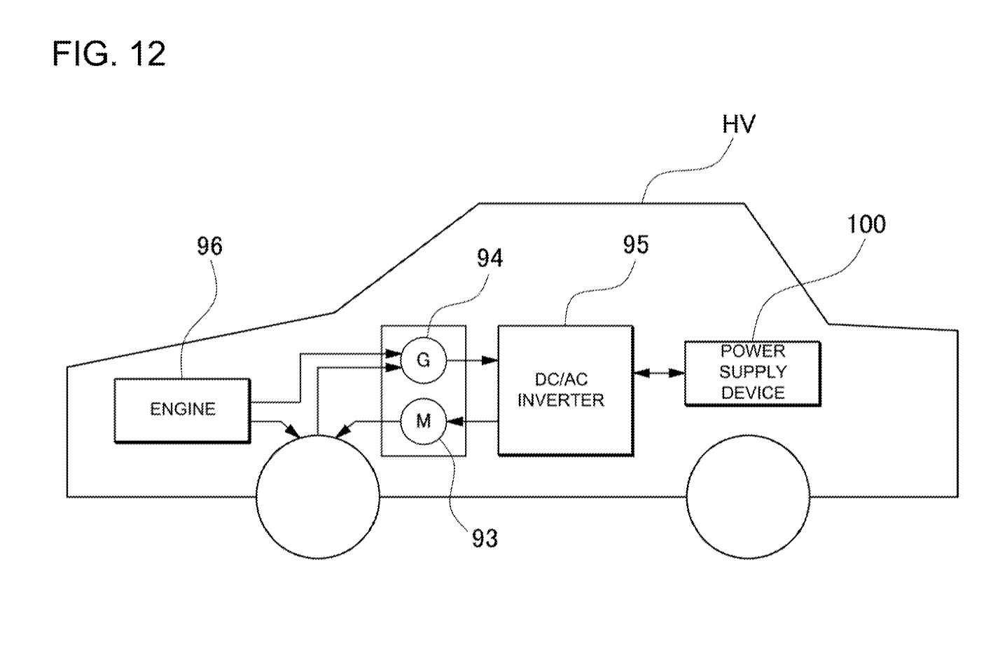

FIG. 12 shows an example that the power supply device is mounted on the hybrid car driven by both engine and motor. The illustrated vehicle HV mounted with the power supply device includes an engine 96 and driving motor 93 for driving the vehicle HV, a power supply device 100 for supplying electric power to the motor 93, and an electric generator 94 for charging a battery in the power supply device 100. The power supply device 100 is connected through a DC/AC inverter 95 to the motor 93 and the electric generator 94. The vehicle HV runs by both motor 93 and engine 96 while charging and discharging the battery in the power supply device 100. The motor 93 runs the vehicle, being driven in a region of a poor engine efficiency, for example, at the time of acceleration or at the time of a low speed drive. The motor 93 is driven by the electric power being supplied by the power supply device 100. The electric generator 94 is driven by the engine 96, or is driven by a regenerative braking when a brake is applied to the vehicle, and thus the battery is charged in the power supply device 100.

### (Power Supply Device for Electric Car)

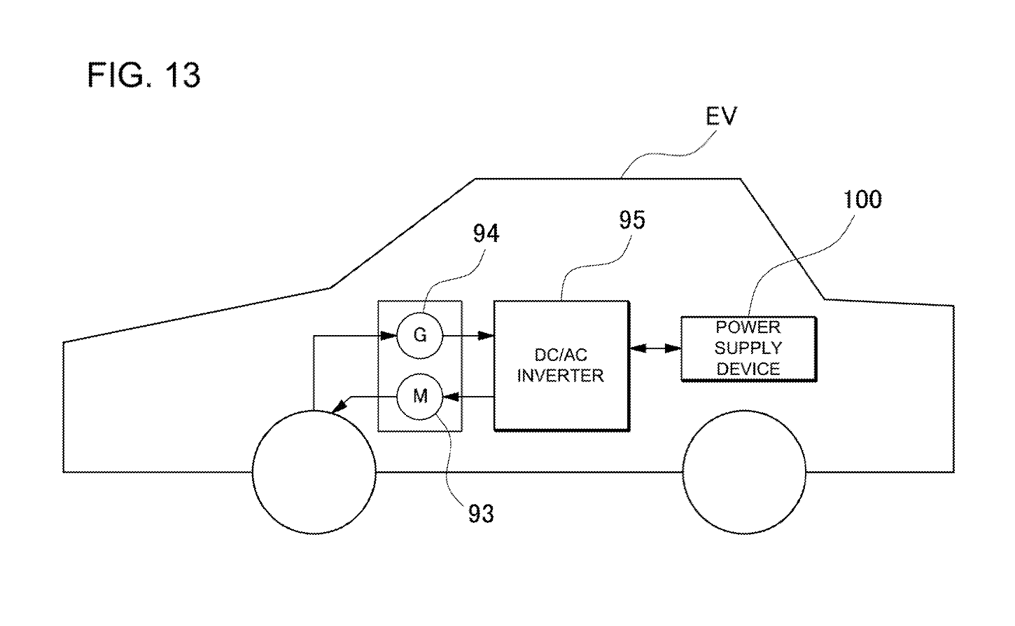

Also shown in FIG. 13 is an example that the power supply device is mounted on an electric car driven by a motor alone. The illustrated vehicle EV mounted with the power supply device includes a driving motor 93 for driving the vehicle EV, a power supply device 100 for supplying electric power to the motor 93, and an electric generator 94 for charging a battery in the power supply device 100. The motor 93 runs the vehicle, with the power being supplied by the power supply device 100. The electric generator 94, being driven by energy generated when the vehicle EV is subjected to a regenerative braking, charges the battery in the power supply device 100.

### (Power Supply Device for Electric Storage Device)

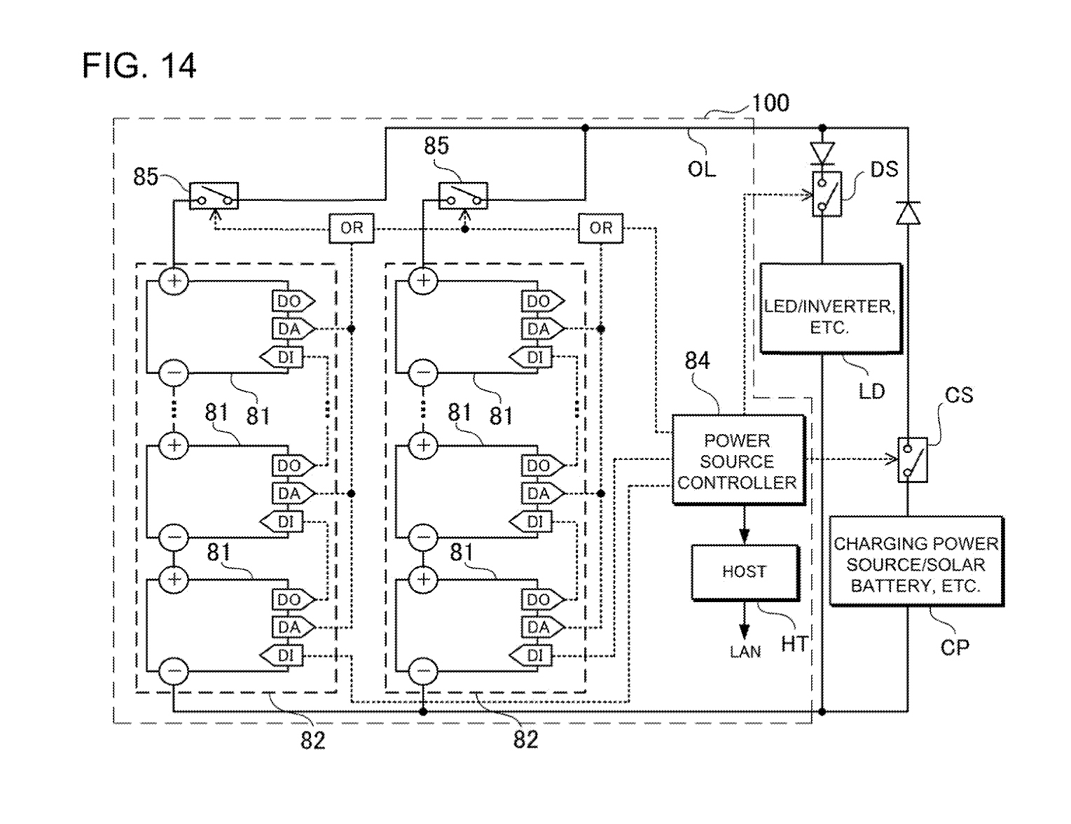

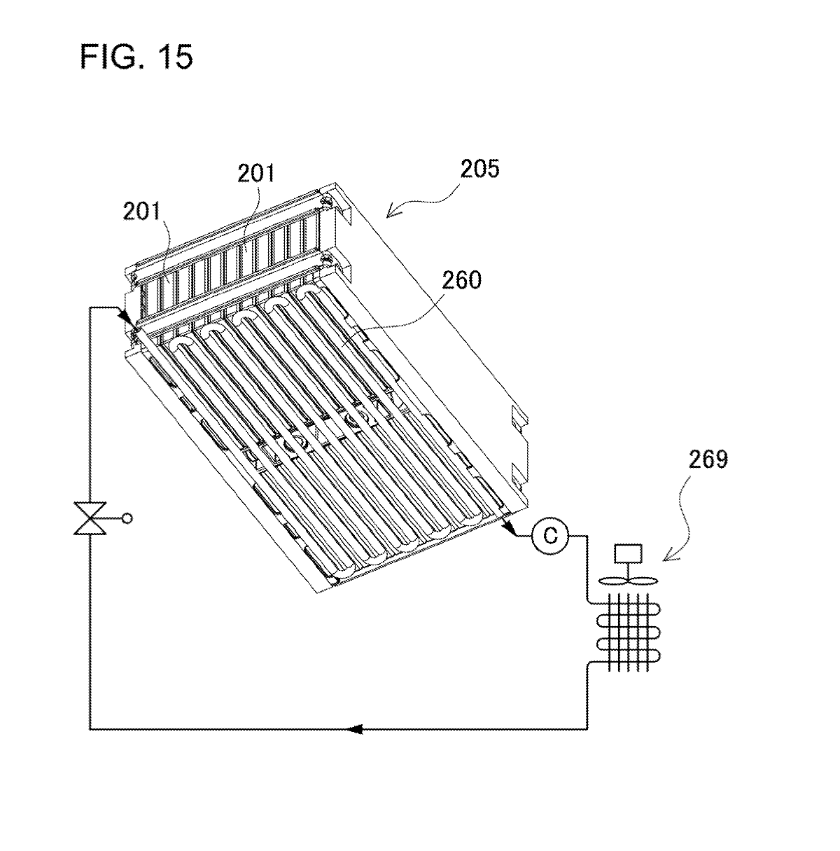

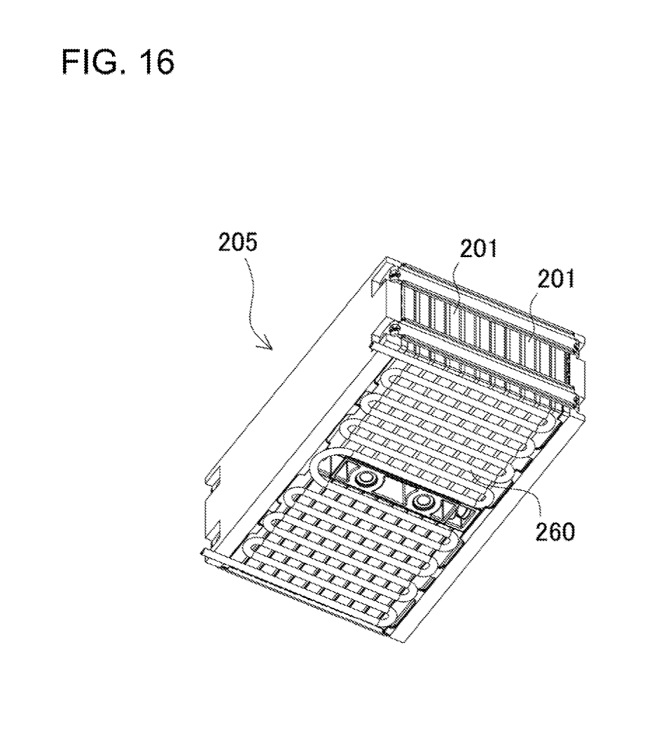

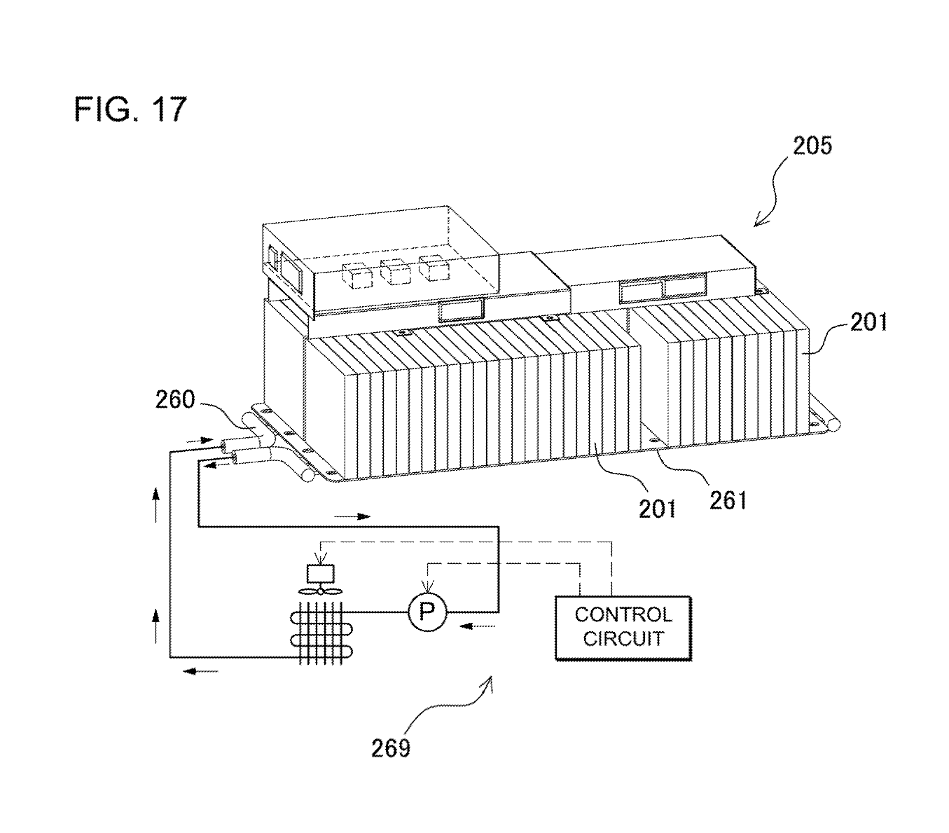

Further, the power supply device can be employed not only as a source of power for a mobile object but also as placeable equipment for electric storage. For example, the power supply device can be used as a power source at homes and factories, being charged by a solar light or by electric power available at a night time and discharged when necessary; as a power source for a street light, being charged by a solar light at a day time and discharged at a night time; or also as a backup power source for a traffic signal driven in the midst of power failure. Such example is shown in FIG. 14. The illustrated power supply device 100 constitutes a battery unit 82 composed of a plurality of battery packs 81 interconnected in a unit state. In each battery pack 81, a plurality of rectangular battery cells 1 are interconnected in series and/or in parallel. Each battery pack 81 is controlled by a power source controller 84. The power supply device 100 drives a load LD after the battery unit 82 has been charged by a charging power source CP. For such purpose, the power supply device 100 is provided with a charging mode and a discharging mode. The load LD and the charging power source CP are respectively connected to the power supply device 100 through a discharging switch DS and a charging switch CS. The discharging switch DS and the charging switch CS are switched ON/OFF by means of the power source controller 84 in the power supply device 100. In a charging mode, the power source controller 84 switches ON the charging switch CS and switches OFF the discharging switch DS, to thus permit a charging operation from the charging power source CP to the power supply device 100. Further, when the charging operation is finished to reach a fully charged state, or in compliance with a request from the load LD in a state that a capacity more than a predetermined value is charged, the power source controller 84 switches OFF the charging switch CS and switches ON the discharging switch DS into a discharging mode, to thus permit a discharging operation from the power supply device 100 to the load LD. Further, optionally, it is also possible to simultaneously perform a power supplying operation to the load LD and a charging operation to the power supply device 100, by switching ON the charging switch CS and also switching ON the discharging switch DS.

The load LD driven by the power supply device 100 is connected through the discharging switch DS to the power supply device 100. In a discharging mode of the power supply device 100, the power source controller 84 switches ON the discharging switch DS, connects to the load LD, and drives the load LD by the electric power from the power supply device 100. A switching element such as an FET can be employed as the discharging switch DS. The ON/OFF switching operation of the discharging switch DS is controlled by the power source controller 84 of the power supply device 100. Further, the power source controller 84 is provided with a communication interface for communicating with outside equipment. In the example shown in FIG. 14, the power source controller is connected to host equipment HT, based on the existing communication protocol such as UART, RS-232C, etc. Optionally, a user interface may also be provided to allow a user to operate the power source system.

Each battery pack 81 is provided with a signal terminal and a power source terminal. The signal terminal includes a pack input/output terminal DI, a pack abnormality output terminal DA, and a pack connection terminal DO. The pack input/output terminal DI is a terminal for inputting and outputting a signal from other battery pack or power source controller 84, and the pack connection terminal DO is a terminal for inputting and outputting a signal with respect to other battery pack being a subsidiary pack. Further, the pack abnormality output terminal DA is a terminal for outputting an abnormality of the battery pack to the outside. Still further, the power source terminal is a terminal for interconnecting the battery packs 81 in series and in parallel. Furthermore, the battery unit 82 is connected through a parallel connection switch 85 to an output line OL, and the battery units 82 are interconnected in parallel.

The power supply device, when mounted on a vehicle, in accordance with the present invention can be suitably used as a power supply device for a plug-in hybrid electric car and a hybrid electric car, which are switchable between an EV drive mode and an HEV drive mode, and also as a power supply device for an electric car. Further, the power supply device is optionally usable as a backup power supply device mountable on a rack for a computer server, as a backup power supply device at a radio base station like for a mobile phone, as a power source for electric storage at homes and factories, as a power source like for a street light, as an electric storage device combined with a solar battery, as a backup power source for a traffic signal, etc.

1-14. (canceled)

15. A power supply device comprising:
a battery cell stack, the battery cell stack being constructed of a plurality of stacked battery cells; and
a cooling pipe disposed in a thermally coupled state over one surface of the battery cell stack, the cooling pipe being adapted to perform a heat exchange with the battery cell stack by allowing a refrigerant to flow therein,
wherein a plurality of rows of the cooling pipes are spaced apart from each other over the one surface of the battery cell stack, and
wherein a resin member is placed between the spaced-apart cooling pipes such that the one surface of the battery cell stack is covered in a sealed state.

16. The power supply device as recited in claim 15, further comprising:
a cover casing for surrounding surfaces other than the one surface of the battery cell stack;
wherein the battery cell stack is sealed around with the cover casing, the cooling pipe, and the covering resin member

17. The power supply device as recited in claim 15, wherein the resin member is a heat insulating member provided with a heat insulating property.

18. The power supply device as recited in claim 15, wherein the cooling pipe is covered around by potting the resin member.

19. The power supply device as recited in claim 18, wherein the cover casing is provided with a surface covering portion between the spaced-apart cooling pipes, the surface covering portion covering the one surface of the battery cell stack.

20. The power supply device as recited in claim 16, wherein the cover casing covers side surfaces and a top surface of the battery cell stack, and wherein the resin member covers the one surface of the battery cell stack and also covers an end surface of the cover casing covering the side surfaces of the battery cell stack, in extension from the one surface.

21. The power supply device as recited in claim 15, wherein the cooling pipe is arranged such that a plurality of rows of the cooling pipe are spaced apart from each other in a substantially parallel form over the one surface of the battery cell stack.

22. The power supply device as recited in claim 21, wherein the plurality of rows of the cooling pipe is configured by meandering a single piece of the cooling pipe.

23. The power supply device as recited in claim 15, further comprising an electrically insulative, thermally conductive member to be interposed between the one surface of the battery cell stack and the cooling pipe.

24. The power supply device as recited in claim 15, wherein the resin member is a urethane-based resin.

25. The power supply device as recited in claim 15, wherein the cooling pipe is composed of an insulating material.

26. The power supply device as recited in claim 15, wherein the cooling pipe is formed into a flat type with a surface thereof opposite to the battery cell stack is flattened.

27. The power supply device as recited in claim 15, wherein the cooling pipe is made of aluminum.

28. A vehicle equipped with the power supply device as recited in claim 15.
